(19) United States
(12) Patent Application Publication
(10) Pub. No.: US 2007/0057031 A1
(43) Pub. Date: Mar. 15, 2007

(54) Light guide plate for keypad backlight panels and method of manufacturing the same

(75) Inventor: Min-kyu Lee, Gimpo-si (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: Hyoung-jun KIM, Songpa-gu (KR)

(21) Appl. No.: 11/517,276

(22) Filed: Sep. 8, 2006

(30) Foreign Application Priority Data
Sep. 12, 2005 (KR) 10-2005-0084793

(51) Int. Cl. G06C 7/02

(52) U.S. Cl. 235/145 R

(57) ABSTRACT

Disclosed herein is a light guide plate for keypad backlight panels, which is mounted at the rear of a keypad having numerals or characters printed thereon for supplying light emitted from a light source mounted at one side of the keypad to the keypad. The light guide plate is made of polycarbonate and is provided at the rear surface thereof with a concave-convex pattern, the density of which is increased as pattern elements of the pattern become more distant from the light source, such that light emitted from the light source is reflected and is uniformly supplied to the keypad, the pattern being formed on the light guide plate by hot stamping, injection molding, or micro blasting. The density of the pattern is adjusted by adjusting the distance between the pattern elements of the pattern or by adjusting the size of the pattern elements of the pattern. Consequently, it is possible to manufacture a keypad module in a slim structure or a curved structure. It is also possible to manufacture a keypad module that is capable of uniformly supplying light.

### BACKGROUND OF THE INVENTION

1. Field of the Invention

The present invention relates to a light guide plate for keypad backlight panels, and, more particularly, to a light guide plate for keypad backlight panels, which is mounted at the rear of a keypad for supplying light emitted from a light emitting device to the keypad, and a method of manufacturing the same.

2. Description of the Related Art

Generally, a keypad module is used as a switch apparatus which is mounted in electronic equipment, such as mobile phones, remote controls, and personal digital assistants (PDAs), to generate signals or to perform various additional functions. The keypad module includes an additional illuminating apparatus which is used to distinguish numerical keys or character keys at night or in a dark place.

FIG. 1 is a sectional view illustrating a conventional direct illumination type light emitting diode (LED) keypad module. As shown in FIG. 1, the keypad module includes a printed circuit board 10, domed members 20, direct illumination LEDS 30, and a keypad 70. The printed circuit board 10 has specific contact terminals 11. The domed members 20 and the direct illumination LEDs 30 are mounted at the front surface of the printed circuit board 10. The keypad 70 is disposed in front of the domed members 20 and the direct illumination LEDs 30. The keypad 70 has numerals and characters printed on the front surface thereof. Also, the keypad 70 is provided at the rear surface thereof with protrusions 71.

In the direction illumination type LED keypad module, the direct illumination LEDs 30, which are mounted at the front surface of the printed circuit board 10, emit light to illuminate the keypad 70. Specifically, when a user pushes the keypad 70, the domed members 20 are connected to the contact terminals 11 of the printed circuit board 10 by the protrusions 71 of the keypad 70, thereby generating a predetermined electric signal, by which the LEDs 30 emit light to directly illuminate the keypad 70 in a spot illuminating fashion.

However, it is practically difficult to manufacture the LED keypad module in a slim structure although chip-type LEDs are used for the LED keypad module. Also, using a large number of LEDs increases the power consumption due to the light emission from the LEDs, and therefore, the operating time of a battery is reduced. Furthermore, the uniformity of the light emission varies depending upon where the LEDs are located.

FIG. 2 is a sectional view illustrating a conventional electroluminescence (EL) keypad module, which has been developed to solve the problems caused in the direct illumination type LED keypad module. As shown in FIG. 2, the EL keypad module includes a printed circuit board 10, domed members 20, an EL sheet 40, and a keypad 70. When a user pushes the keypad 70, the domed members 20 are connected to contact terminals 11 of the printed circuit board 10 by protrusions 71 of the keypad 70, thereby generating a predetermined electric signal, by which the EL sheet 40 emits light to uniformly illuminate the keypad 70.

It is possible to manufacture the EL keypad module in a slim structure. However, the service life of the EL sheet 40 is shorter than that of each LED, the EL keypad module generates noise against an LCD module, and the reliability of the EL keypad module is decreased. Furthermore, the manufacturing costs of the EL keypad module are higher than those of the LED keypad module.

FIG. 3 is a sectional view illustrating a conventional indirect illumination type LED keypad module, which has been developed to solve the problems caused in the EL keypad module. As shown in FIG. 3, the indirect illumination type LED keypad module includes a printed circuit board 10, domed members 20, an indirect illumination LED 50, a light guide plate 60, and a keypad 70. The indirect illumination LED 50 is mounted at one side of the printed circuit board 10, and therefore, it is possible to manufacture the indirect illumination type LED keypad module in a slim structure. When a user pushes the keypad 70, the domed members 20 are connected to contact terminals 11 of the printed circuit board 10 by protrusions 71 of the keypad 70, thereby generating a predetermined electric signal, by which the indirect illumination LED 50 emits light. The light is dispersed by the light guide plate 60 such that the keypad 70 can be uniformly illuminated in a face illuminating fashion.

An example of the indirect illumination type LED keypad module is disclosed in Korean Utility Model Application No. 2004-7273. As shown in FIG. 4, an optical fiber 61 having high transmission properties is additionally disposed on the light guide plate 60 so as to uniformly transmit light emitted from the indirect illumination LED 50 to the keypad 70. However, this light guide plate 60 is basically made of silicone, and therefore, it is not possible to manufacture the light guide plate 60 in a slim structure. Furthermore, application of the light guide plate 60 is practically difficult.

### SUMMARY OF THE INVENTION

Therefore, the present invention has been made in view of the above problems, and it is an object of the present invention to provide a light guide plate for keypad backlight panels that can be manufactured in a slim structure, can uniformly supply light having high brightness in a face illuminating fashion even through a small number of light sources are used, or can supply light to a desired region in a spot illuminating fashion, and a method of manufacturing the same.

In accordance with one aspect of the present invention, the above and other objects can be accomplished by the provision of a light guide plate for keypad backlight panels, which is mounted at the rear of a keypad having numerals or characters printed thereon for supplying light emitted from a light source mounted at one side of the keypad to the keypad, wherein the light guide plate is made of polycarbonate and is provided at the rear surface thereof with a concave-convex pattern, the density of which is increased as pattern elements of the pattern become more distant from the light source, such that light emitted from the light source is reflected and is uniformly supplied to the keypad, the pattern being formed on the light guide plate by hot stamping, injection molding, or micro blasting, and the density of the pattern is adjusted by adjusting the distance between the pattern elements of the pattern or by adjusting the size of the pattern elements of the pattern.

In accordance with another aspect of the present invention, there is provided a light guide plate for keypad backlight panels, which is mounted at the rear of a keypad having numerals or characters printed thereon for supplying light emitted from a light source mounted at one side of the keypad to the keypad, wherein the light guide plate is made of polycarbonate and is provided at the rear surface thereof with a dot-type pattern, the density of which is increased as pattern elements of the pattern become more distant from the light source, such that light emitted from the light source is reflected and is uniformly supplied to the keypad, the pattern being formed on the light guide plate by a method of printing ink containing an optical dispersing agent, and the density of the pattern is adjusted by adjusting the distance between the pattern elements of the pattern or by adjusting the size of the pattern elements of the pattern.

Preferably, the pattern elements of the pattern are formed at regions corresponding to the numerals or the characters of the keypad. The pattern elements of the pattern may be formed in the shape of the numerals or the characters of the keypad.

In accordance with yet another aspect of the present invention, there is provided a method of manufacturing a light guide plate for keypad backlight panels, which is mounted at the rear of a keypad having numerals or characters printed thereon for supplying light emitted from a light source mounted at one side of the keypad to the keypad, wherein the method comprises the steps of: etching (corroding) a hot stamper mold to form a pattern on the hot stamper mold; heating the hot stamper mold having the pattern formed by the etching; and pressing the heated mold against a light guide plate made of polycarbonate to transfer the pattern to the light guide plate, the temperature at which the mold is heated being 150° C. to 250° C.

Preferably, the light guide plate is previously processed by a computer numeric control (CNC) machine or a press stamping mold.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view illustrating a conventional direct illumination type light emitting diode (LED) keypad module;

FIG. 2 is a sectional view illustrating a conventional electroluminescence (EL) keypad module;

FIG. 3 is a sectional view illustrating a conventional indirect illumination type LED keypad module;

FIG. 4 is a view illustrating a light guide plate for keypad backlight panels applied to the keypad module of FIG. 3;

FIG. 5 is a view illustrating a light guide plate for keypad backlight panels according to a first embodiment of the present invention;

FIG. 6 is a view illustrating a light guide plate for keypad backlight panels according to a second embodiment of the present invention;

FIG. 7 is a view illustrating a light guide plate for keypad backlight panels according to a third embodiment of the present invention;

FIG. 8 is a view illustrating a light guide plate for keypad backlight panels according to a fourth embodiment of the present invention;

FIG. 9 is a view illustrating a light guide plate for keypad backlight panels according to a fifth embodiment of the present invention;

FIG. 10 is a graph illustrating pattern density distribution of the light guide plate for keypad backlight panels according to the present invention; and

FIG. 11 is a flow chart illustrating a method of manufacturing a light guide plate for keypad backlight panels according to the present invention.

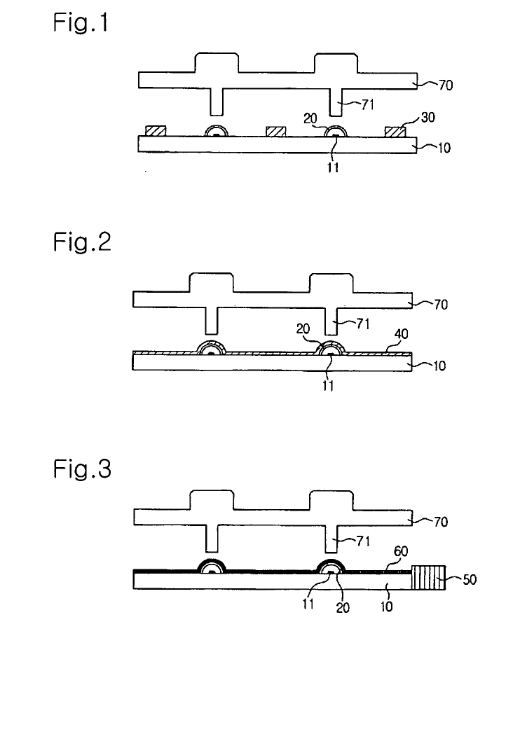

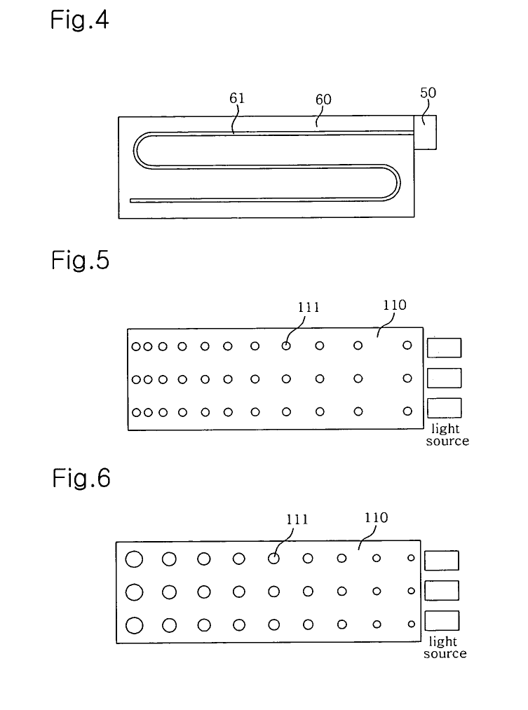

### DESCRIPTION OF THE PREFERRED EMBODIMENTS

Now, preferred embodiments of the present invention will be described in detail with reference to the accompanying drawings.

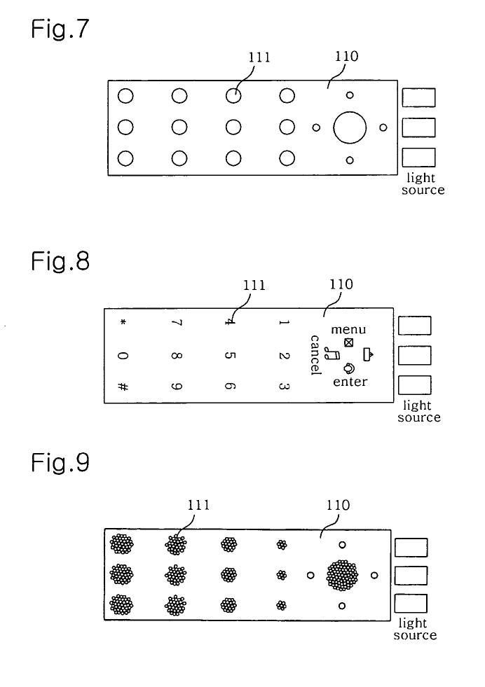

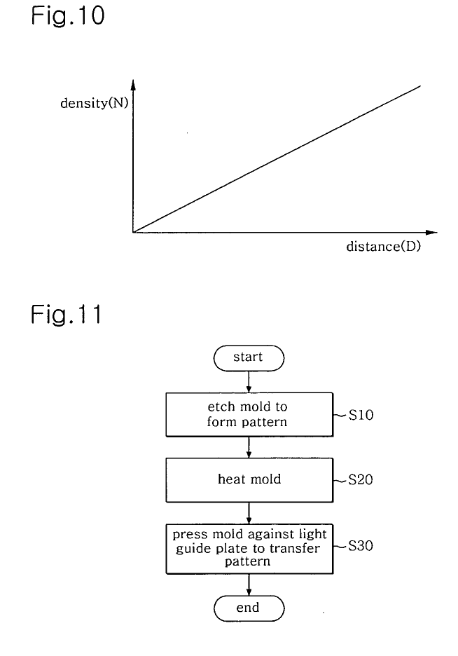

FIG. 5 is a view illustrating a light guide plate 110 for keypad backlight panels according to a first embodiment of the present invention, FIG. 6 is a view illustrating a light guide plate 110 for keypad backlight panels according to a second embodiment of the present invention, FIG. 7 is a view illustrating a light guide plate 110 for keypad backlight panels according to a third embodiment of the present invention, FIG. 8 is a view illustrating a light guide plate 110 for keypad backlight panels according to a fourth embodiment of the present invention, FIG. 9 is a view illustrating a light guide plate 110 for keypad backlight panels according to a fifth embodiment of the present invention, and FIG. 10 is a graph illustrating pattern density distribution of the light guide plate 110 for keypad backlight panels according to the present invention.

Referring to the drawings, the light guide plate 110 according to the present invention is made of polycarbonate having high flexibility. The light guide plate 110 is provided at the rear surface thereof with a predetermined pattern 111, the density of which is increased as pattern elements of the pattern 111 become more distant from the light sources, such that light emitted from the light sources is reflected, and, by diffusion or dispersion, is uniformly supplied to the keypad, in a face illuminating fashion.

The pattern 111 may be formed by hot stamping, injection molding, micro blasting, or laser. A pattern forming method using the hot stamping is carried out as follows. As widely known, a stamper mold having a predetermined pattern formed thereon is heated, and then the heated stamper mold is pressed against a light guide plate under pressure having a predetermined level such that the pattern formed on the stamper mold is transferred to the light guide plate, whereby a concave-convex pattern is formed. A pattern forming method using the injection molding is carried out as follows. A previously manufactured pattern mold is used to form a concave-convex pattern on the light guide plate. A pattern forming method using the micro blasting is carried out as follows. Micro particles, such as sand particles or glass particles, are injected to the light guide plate, using spray, to form a concave-convex pattern on the light guide plate.

On the other hand, the pattern 111 may be formed on the light guide plate using a method of printing ink containing an optical dispersing agent. Specifically, the ink containing the optical dispersing agent is printed on the rear surface of the light guide plate in a dot fashion, thereby forming a dot-type pattern.

The density of the pattern may be adjusted by decreasing the distance between pattern elements of the pattern 111 as the pattern elements become more distant from the light sources, as shown in FIG. 5, or by increasing the size of the pattern elements of the pattern 111 as the pattern elements become more distant from the light sources, as shown in FIG. 6.

As shown in FIGS. 7, 8, and 9, the pattern elements of pattern 111 may be formed at specific regions corresponding to numerals or characters of the keypad so as to accomplish the efficient use of light. Specifically, the pattern elements of the pattern 111 may be formed at regions corresponding to the numerals or the characters of the keypad in a dot pattern such that the keypad can be partially illuminated in a spot illuminating fashion. Preferably, the pattern elements of the pattern 111 are formed in the shape of the numerals or the characters printed on the keypad.

However, the shape of the pattern 111 is not particularly restricted. As an example, the pattern 111 may be formed or printed on the surface of the light guide plate 110 such that the density of the pattern is increased in proportion to the distance between the pattern elements of the pattern and the light sources, as shown in FIG. 10.

When the predetermined pattern 111 is formed on the light guide plate 110, which is made of a flexible polycarbonate material, such that light emitted to the light guide plate 110 can be diffused or dispersed with uniform brightness in a face illuminating fashion, as described above, it is possible to apply the light guide plate 110 to curved keypad modules as well as slim-type keypad modules. Furthermore, the light guide plate 110 can uniformly supply light having high brightness, which is luminous intensity of a light source having a predetermined area or the surface of a light reflecting body.

FIG. 11 is a flow chart illustrating a method of manufacturing a light guide plate for keypad backlight panels according to the present invention.

As shown in FIG. 11, one side of a hot stamper mold is etched, i.e., corroded, in a predetermined pattern (S10). Subsequently, the mold having the etched pattern is heated to approximately 150° C. to 250° C. (S20), and the heated mold is pressed against a light guide plate, which is made of polycarbonate and has been previously processed by a computer numeric control (CNC) machine or a press stamping mold, under pressure, such as air pressure or hydraulic pressure, having a predetermined level, such that the pattern is transferred to the light guide plate (S30).

By using the light guide plate manufacturing method as described above, it is possible to manufacture a light guide plate that can uniformly supply light having high brightness and can be formed in a slim structure.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

As apparent from the above description, the light guide plate for keypad backlight panels is made of a polycarbonate, and therefore, it is possible to manufacture a keypad module in a slim structure or a curved structure. Furthermore, the light guide plate is provided at the rear surface thereof with a predetermined pattern, the density of which is increased as pattern elements of the pattern become more distant from the light sources, and therefore, it is possible to manufacture a keypad module that is capable of uniformly supplying light. Consequently, it is possible to manufacture a keypad module that is inexpensive and has competitiveness.

What is claimed is:

1. A light guide plate for keypad backlight panels, which is mounted at the rear of a keypad having numerals or characters printed thereon for supplying light emitted from a light source mounted at one side of the keypad to the keypad, wherein
the light guide plate is made of polycarbonate and is provided at the rear surface thereof with a concave-convex pattern, the density of which is increased as pattern elements of the pattern become more distant from the light source, such that light emitted from the light source is reflected and is uniformly supplied to the keypad, the pattern being formed on the light guide plate by hot stamping, injection molding, or micro blasting, and
the density of the pattern is adjusted by adjusting the distance between the pattern elements of the pattern or by adjusting the size of the pattern elements of the pattern.

2. A light guide plate for keypad backlight panels, which is mounted at the rear of a keypad having numerals or characters printed thereon for supplying light emitted from a light source mounted at one side of the keypad to the keypad, wherein
the light guide plate is made of polycarbonate and is provided at the rear surface thereof with a dot-type pattern, the density of which is increased as pattern elements of the pattern become more distant from the light source, such that light emitted from the light source is reflected and is uniformly supplied to the keypad, the pattern being formed on the light guide plate by a method of printing ink containing an optical dispersing agent, and
the density of the pattern is adjusted by adjusting the distance between the pattern elements of the pattern or by adjusting the size of the pattern elements of the pattern.

3. The light guide plate according to claim 1, wherein the pattern elements of the pattern are formed at regions corresponding to the numerals or the characters of the keypad.

4. The light guide plate according to claim 3, wherein the pattern elements of the pattern are formed in the shape of the numerals or the characters of the keypad.

5. The light guide plate according to claim 4, wherein the shape of the pattern elements of the pattern is a circle, an ellipse, or a polygon.

6. The light guide plate according to claim 2, wherein the pattern elements of the pattern are formed at regions corresponding to the numerals or the characters of the keypad.

7. The light guide plate according to claim 6, wherein the pattern elements of the pattern are formed in the shape of the numerals or the characters of the keypad.

8. The light guide plate according to claim 7, wherein the shape of the pattern elements of the pattern is a circle, an ellipse, or a polygon.

9. A method of manufacturing a light guide plate for keypad backlight panels, which is mounted at the rear of a keypad having numerals or characters printed thereon for supplying light emitted from a light source mounted at one side of the keypad to the keypad, wherein the method comprises the steps of:
etching (corroding) a hot stamper mold to form a pattern on the hot stamper mold;
heating the hot stamper mold having the pattern formed by the etching; and
pressing the heated mold against a light guide plate made of polycarbonate to transfer the pattern to the light guide plate,
the temperature at which the mold is heated being 150° C. to 250° C.

10. The method according to claim 9, wherein the light guide plate is previously processed by a computer numeric control (CNC) machine or a press stamping mold.
